(19) United States
(12) Patent Application Publication
(10) Pub. No.: US 2014/0125109 A1
(43) Pub. Date: May 8, 2014

(54) Seat Adjuster Having a Rocker

(71) Applicant: Jörg Schwarzbich, Bielefeld (DE)

(72) Inventor: Jörg Schwarzbich, Bielefeld (DE)

(73) Assignee: ROLLAX GMBH & CO. KG, Bad Salzuflen (DE)

(21) Appl. No.: 14/127,691

(22) PCT Filed: Jun. 12, 2012
(86) PCT No.: PCT/EP2012/061096

§ 371 Date: Dec. 19, 2013

(30) Foreign Application Priority Data
Jun. 21, 2011 (DE) 202011050521.9

(51) Int. Cl. B60N 2/02

(52) U.S. Cl. CPC B60N 2/02
USPC 297/463.1

(57) ABSTRACT

A seat adjuster comprising includes a crank (12; 12′) that is rotatable about an axis (A), and a pinion (14) meshing with a toothed segment 16 of the crank (12; 12′) that is centered on the axis (A), c hat and the crank (12; 12′) is formed by a packet of at least three lamella (18; 18a; 18b) that are stacked one upon the other and firmly held together.

The invention relates to a seat adjuster having a crank that is rotatable about an axis, and a pinion having a toothed segment that is centered on said axis.

Seat adjusters of this type are used for example in automotive vehicles for adjusting the inclination of the seat back or adjusting the height of the seat. For example, in case of a seat height adjuster, the crank is rotatably mounted on a frame of the seat, whereas a free end of the crank is articulated to a member that is rigidly connected to the vehicle body. The pinion is driven by means of an electric motor or manually via a lever and drives the crank, via the toothed segment, to perform a pivotal movement with the result that the position of the seat frame changes relative to the member that is connected the vehicle body. When the desired seat position has been reached, the pinion is blocked in the position that it has reached, for example by means of a free wheel brake, so that the crank and the seat frame are also immobilized in the desired position.

U.S. Pat. No. 4,633,556 A discloses toothed gears and cams that are each formed by a packet of lamella stacked one upon the other, which may simply be punched from relatively thin sheet metal. For minimizing waste, the cams are punched out of the area of the gear, so that openings with shapes corresponding to those of the cams are left in the gear.

In seat adjusters for automotive vehicles, the crank must have a very high mechanical strength and breaking resistance, in order to assure the safety of the vehicle passengers belted to the seat in case of an accident.

For this reason, in known seat adjusters of the type mentioned above, the crank is punched from a relatively thick sheet.

It is an object of the invention to provide a seat adjuster with improved breaking resistance.

According to the invention, this object is achieved by the feature that the crank is formed by a packet of at least three lamella that are stacked one upon the other and tightly held together.

If, in case of a collision of the vehicle, the forces of inertia acting upon the seat result in a rupture of the crank, then this rupture typically starts from a minute crack that forms in the most strained portion of the crank and then spreads unobstructedly over the entire crank. In contrast, in the seat adjuster according to the invention, the spreading of the crack remains confined to the concerned lamella whereas the other lamella remain faultless, initially, and since the lamella are tightly held together, obstruct the spreading of the crack of the failing lamella. In this way, a considerable portion of the impact energy can be consumed, thus avoiding a failure of the entire crank which would the result in the vehicle seat being torn off from its mount.

Since, moreover, the thickness of the sheet to be punched in a single punching step corresponds only to the thickness of a single lamella, it is possible to use, for a given force of the punching press, sheet metals with a higher hardness, so that the mechanical strength of the crank is increased further or the total thickness and, accordingly, the weight of the crank can be reduced without compromising the strength.

Surprisingly, the manufacture of the crank from a plurality of lamella that are punched-out individually does not lead to an increase of the total waste, neither, but on the contrary to a reduction of the waste percentage. Basically, this is due to the fact that, because of the smaller cutting forces, the grip area that surrounds the lamella to be punched-out and with which the blank is firmly held in the punching tool during the punching process may be reduced.

Advantageous embodiments and further developments of the invention are indicated in the dependent claims.

In a particularly preferred embodiment, lamella with different shapes are combined in a single crank. In this way, it may be achieved that the crank is formed by the full number of lamella only in those regions that are strained most, whereas regions that are subject to lower strain may be formed by only a smaller number of lamella, resulting in savings of material and waste.

It may also be advantageous to combine lamella with different thicknesses and/or lamella from sheet metals of different grades. For example, by combining harder sheets with softer and more ductile sheets, the hardness of the crank as a whole may be increased while the brittleness is kept in acceptable limits.

Embodiment examples of the invention will now be explained in conjunction with the drawings, wherein:

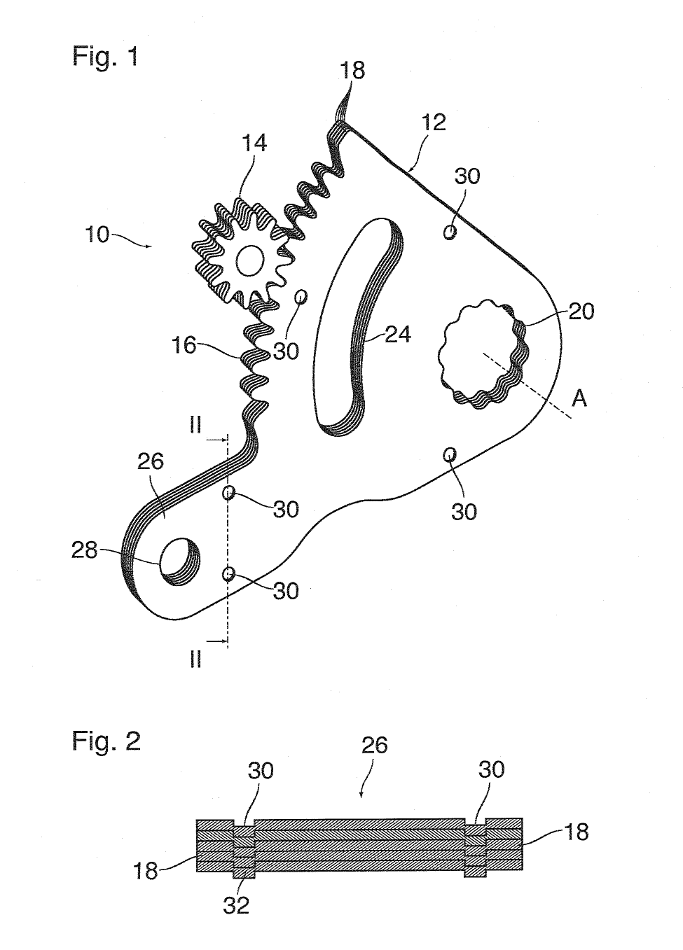

FIG. 1 is a perspective view of a crank and a pinion of a seat adjuster according to an embodiment of the invention;

FIG. 2 is a sectional view taken along the line II-II in FIG. 1;

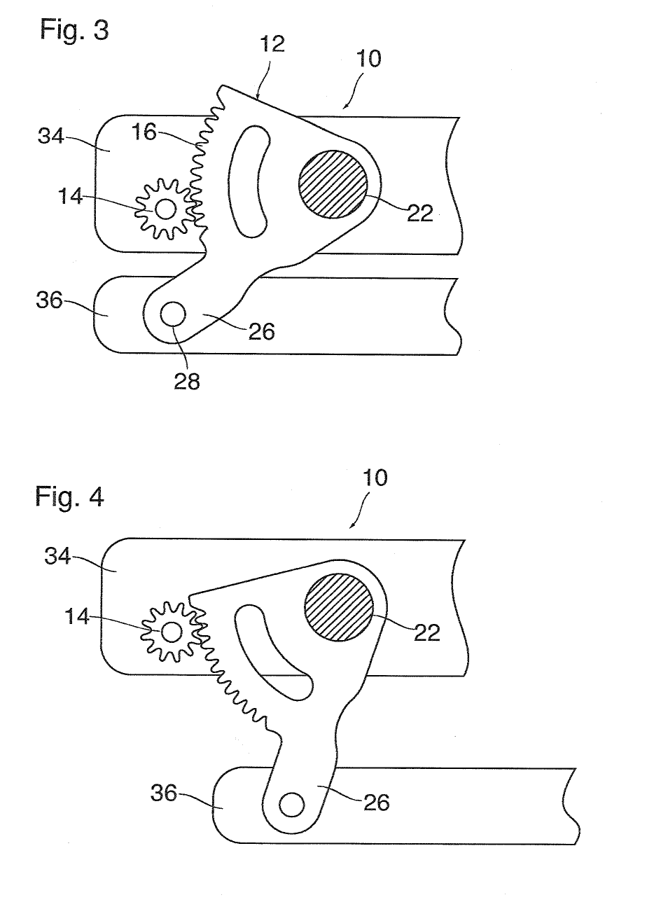

FIG. 3 is a sketch of a seat adjuster having the crank and the pinion shown in FIG. 1;

FIG. 4 is a sketch of the seat adjustor as shown in FIG. 3 in a different position;

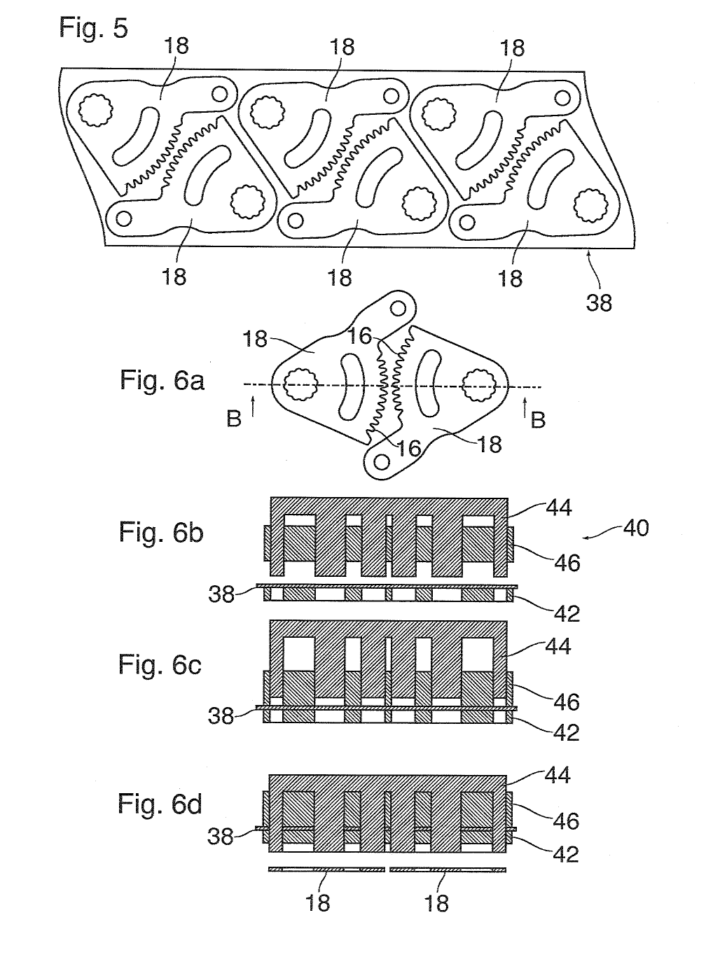

FIG. 5 is an example of an arrangement of punching positions in a blank formed by an endless strip of sheet metal from which the lamella for the crank are punched;

FIG. 6a-d are views for illustrating the punching process;

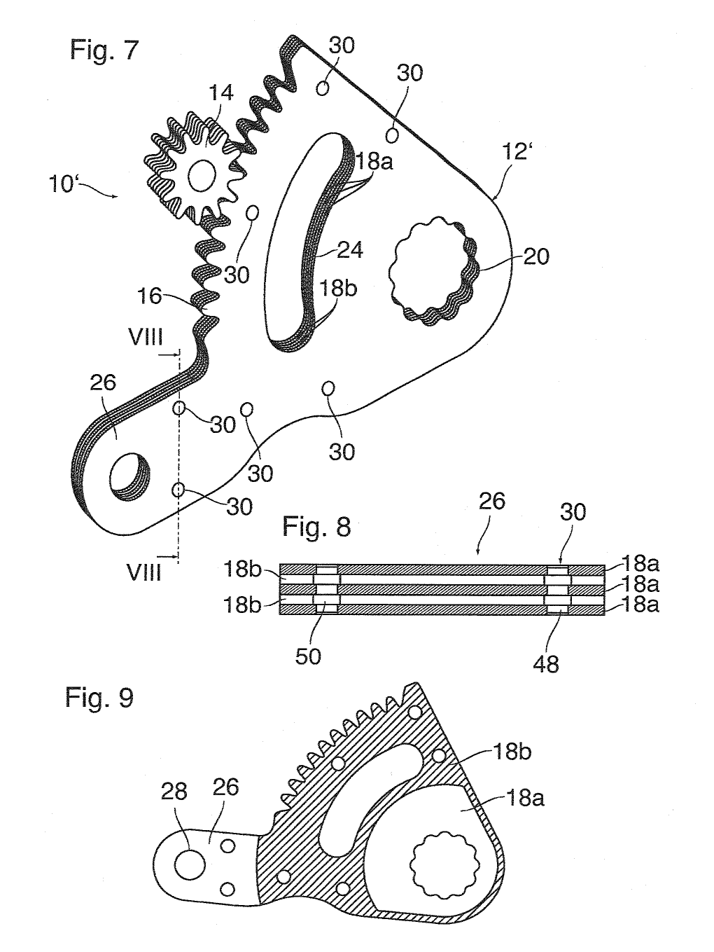

FIG. 7 is a perspective view of a crank of a seat adjuster according to another embodiment;

FIG. 8 is a sectional view taken along the line VIII-VIII in FIG. 7;

FIG. 9 is a schematic plan view of the crank shown in FIG. 7; and

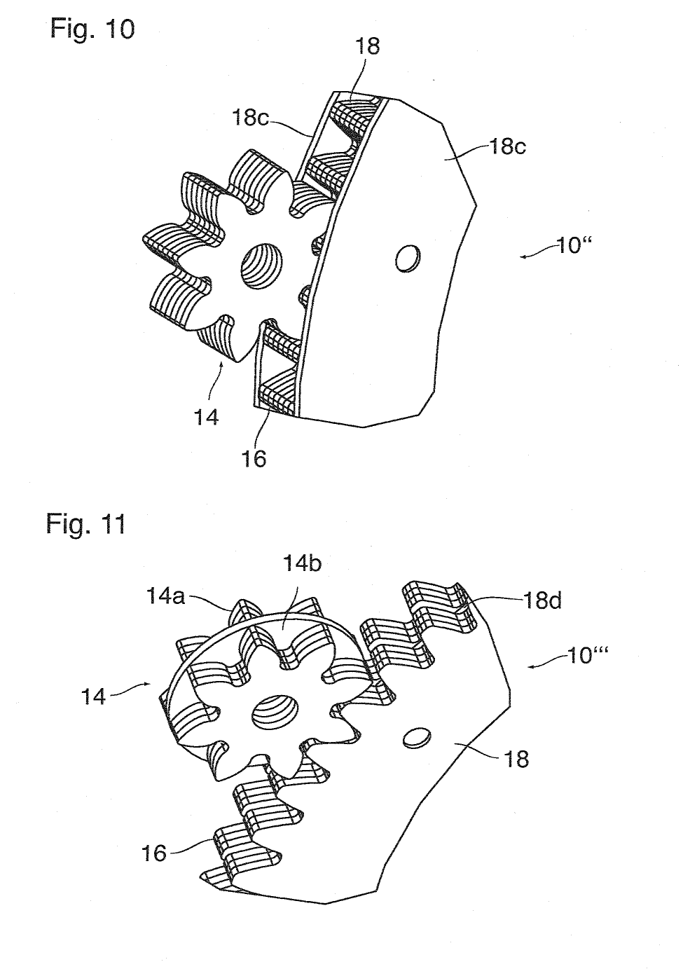

FIGS. 10 and 11 are perspective detail views of seat adjusters according to further embodiments.

In FIG. 1, essential parts of a seat adjustor 10 have been shown to comprise a crank 12 and a pinion 14 that meshes with a toothed segment 16 of the crank 12.

The crank 12 is formed by a packet of several—five in this example—lamella 18 stacked one upon another and having all the same contour in this example. The crank 12 has an opening 20 which is approximately circular but has a corrugated edge and with which the crank can be keyed non-rotatably on a shaft 22 (FIG. 3). Thus, the opening 20 defines an axis A about which the crank 12 is rotatable. The toothed segment 16 forms an arc of a circle that is centered on the axis A. Furthermore, the crank 12 has an arcuate cut-out 24 that is also centered on the axis A and is penetrated for example by a stop that has not been shown and that limits the range of pivotal movement of the crank 12. At one end of the toothed segment 16, the crank 12 forms an extension 26 that projects radially beyond the toothed segment 16 and in which a joint opening 28 is formed.

In the example shown, the pinion 14 is also composed of a plurality of stacked lamella, which, however, is not essential for understanding the invention.

The individual lamella 18 of the crank 12 are form-fittingly caulked with one another at a plurality of fixing points 30 that are distributed over the area of the crank. FIG. 2 shows a section through two of these fixing points 30 in the region of the extension 26. At each of the fixing points 30, each of the lamella 18 has a punched depression on one side and a complementary punched projection 32 on the opposite side, the projection being press-fitted in the recession of the neighbouring lower lamella. In this way, the lamella are held together as a packet.

The construction and function of the seat adjuster 10 shall be explained by reference to FIGS. 3 and 4.

FIG. 3 shows one end of a seat frame 34 and a corresponding end of a member 36 that is rigidly connected to the body of an automotive vehicle. The crank is held co-rotatably on the shaft 22 that had been mentioned before and that is rotatably supported in two legs of the seat frame 34 (only one of these legs is visible in FIGS. 3 and 4, respectively). The extension 26 of the crank is articulated to the body-fixed member 36. The two other ends of the seat frame 34 and the member 36, which have not been shown in FIG. 3, are connected by a link that has a similar construction as the crank 12 but does not have a toothed segment. Thus, the crank 12 and said link constitute a rhomboid linkage that permits a movement of the seat frame 34 relative to the member 36 as shown in FIG. 4.

The pinion 14 is rotatably supported on the seat frame 34 and is driven by a drive mechanism that has not been shown, e.g. an electric motor or a gear and a manipulating lever. As the pinion 14 meshes with a toothed segment 16, a rotation of the pinion translates into a pivotal movement of the crank 12 about the axis A that is defined by the. shaft 22, and, accordingly, the seat frame 34 is adjusted in height relative to the member 36. The drive train for the pinion 14 includes a free wheel brake that assures that the pinion 14, when it is not driven, is self-lockingly immobilized in its position and thereby holds also the crank 12 in the angular position that has been reached.

FIG. 5 illustrates how the lamella 18 for a plurality of cranks 12 can efficiently be punched from a blank 38 that is supplied to a punching press in the form of an endless strip of sheet metal. In the example shown, the punching positions have been selected such that the toothed segments of two cranks, respectively, are opposed to one another and spaced apart only by a small distance in the blank.

The punching process has been illustrated in FIGS. 6a-6d.

FIG. 6a shows the contours of two lamella 18 the toothed segments of which are opposed to one another as described above.

FIG. 6b shows the essential parts of a punching press 40 in a sectional view corresponding to the line B-B in FIG. 6a. The punching device has a matrix 42 and a punch 44 that is complementary thereto and passes through corresponding openings of a clamping tool 46. In FIG. 6b, a newly supplied portion of the blank 38 is placed on the matrix 42 whereas the punch 44 and the clamping tool 46 are lifted.

In FIG. 6c, the clamping tool 46 has been lowered so that the blank 38 is firmly clamped between the matrix 42 and the clamping tool 46. It is essential that, along all cutting lines that surround the lamella 18 and the openings thereof, the blank is clamped over a sufficient width that assures that the cutting forces that occur during the punching process will not result in a distortion of the sheet, but the sheet will be cut neatly. In particular, this holds true for the web that separates the two toothed segments 16 of the lamella 18 from one another (FIG. 6a), because, here, the cutting forces per unit area are particularly high due to the tooth contours.

FIG. 6d shows the condition after the punching step. The punch 44 has been lowered so that its cutting projections have passed through the openings in the matrix 42. Accordingly, two punched lamella 18 are ejected downwardly whereas the rest of the blank 38 remains as waste in the punching device and will be removed later when the blank is advanced.

Since the blank 38 has to have only the thickness of a single lamella 18, the cutting force occurring in the punching process described above are relatively small. This permits, on the one hand, to use for the blank 38 a sheet metal grade that has a particularly high hardness and/or toughness, so that a higher strength of the crank 12 is achieved for a given total thickness. On the other hand, due to the smaller sheet thickness, the areas in which the blank 38 is clamped between the matrix 42 and the clamping tool 46 outside of the lamella 18 to be punched-out may be kept relatively small. Would the entire crank 12 be punched from a single sheet having a thickness larger by a factor of five, then the cutting forces, in particular in the region of the toothed segments 16, would become so high that a significantly larger space between the two toothed segments would be required in order for the webs of the matrix 42 and the clamping tool 46, that hold the sheet between the toothed segments 16, to have a sufficient stability and to clamp the sheet so firmly that the metal will not flow, but the sheet will be cut smoothly. In this case, the distances between the individual punching positions would have to be significantly larger, so that the total mass of the produced waste in relation to the mass of the cranks being produced would be significantly larger.

FIGS. 7 to 9 show a seat adjuster 10′ according to a modified embodiment. In place of the crank 12, this seat adjuster has a crank 12′ that is also formed by a packet of five lamella 18b, 18b, but wherein the lamella do not have all the same contour. Only the lamella 18a extend over entire contour of the crank 12′, whereas interposed therebetween are lamella 18b which extend only over a part of the contour and, in particular, avoid the region of the extension 26 as well as the surroundings of the opening 20. This can best be seen in FIG. 9 where the contour of the lamella 18b has been hatched. Combining the lamella 18a and 18b achieves savings in material and weight without compromising the load carrying capacity of the crank 12′. In those areas where particularly high forces act upon the crank, in particular in the region of the toothed segment 16, the crank is reinforced by five lamella 18a, 18b being stacked one upon the other. In contrast, at the corrugated edge of the opening 20, the forces corresponding to a given torque are distributed over the entire periphery of the shaft 22 (FIG. 3), so that, here, the three lamella 18a provide a sufficient stability. Here, the lamella 18b form only narrow margins at the outer periphery of the crank, serving as spacers between the lamella 18a and stabilising the packet.

Also, the forces occurring in the joint opening 28 in the extension 26 are relatively small for a given torque, because the forces are distributed over a larger area at the periphery of the joint opening 28 and, moreover, the force is reduced due to the greater leverage.

At the fixing points 30, the lamella 18a and 18b are held together in this example by means of pins 48 that are inserted therethrough, as shown in FIG. 8. In those regions, where only the lamella 18a are present, such as in the region of the extension 26, the lamella 18a may be spaced apart from one another by means of spacer rings 50 that are thrust onto the pins 48. The pins 48 may be held in press-fit in the corresponding openings of the lamella, so that they hold the entire packet together.

FIG. 10 shows a crank 10″ in which the packet of the lamella 18 is covered on both sides by lamella 18c with a different shape which, in the region of the toothed segment 16, extend into the gaps between the teeth and thereby help to guide the pinion 14 in axial direction.

FIG. 11 illustrates the reversal of this principle. A crank 10′″ has a lamella 18d which is flanked by “normal” lamella 18 on both sides and in which the teeth have been omitted in the region of the toothed segment 16. The pinion 14 is formed by a packet of lamella 14a, 14b. At least one lamella 14b extends into the gaps between the teeth of the pinion and engages between the lamella 18 of the crank 10′″ for axial guidance of the pinion 14.

What is claimed is:

1. A seat adjuster comprising:
a crank that is rotatable about an axis and having a toothed segment centered on said axis,
a pinion meshing with the toothed segment of the crank, and
the crank being formed by a packet of at least three lamella that are stacked one upon the other and firmly held together.

2. The seat adjuster according to claim 1, wherein at least one of the lamella encompasses only a part of a contour of the crank

3. The seat adjuster according to claim 1, wherein the toothed segment is formed by lamella having a first peripheral shape and at least one further lamella having a second peripheral shape and extending beyond the lamella having the first peripheral shape in the region of the toothed segment for giving axial guidance to the pinion.

4. The seat adjuster according to claim 1, wherein the toothed segment is formed by lamella with a first peripheral shape and at least one further lamella that has a second peripheral shape and is recessed in the vicinity of the toothed segment relative to the lamella with the first peripheral shape so as to form a space, and wherein the pinion is formed by a packet of lamella at least one of which gives axial guidance to the pinion by engaging into the space that is left by the recessed lamella of the crank.

5. The seat adjuster according to claim 1, wherein the lamella have depressions and projections that are complementary to one another for form-fittingly locking the lamella to one another.

6. The seat adjuster according to claim 1 wherein the lamella are form-fittingly locked together by pins inserted therethrough.

7. The seat adjuster according to claim 1, wherein the lamella include lamina having one of a different thickness and a different sheet metal grade which are combined to form the crank.
